(19) United States
(12) Patent Application Publication
(10) Pub. No.: US 2018/0162086 A1
(43) Pub. Date: Jun. 14, 2018

(54) HONEYCOMB PAPER

(71) Applicant: SABIC GLOBAL TECHNOLOGIES B.V., BERGEN OP ZOOM (NL)

(72) Inventor: Erich Otto TEUTSCH, Richmond, MA (US)

(21) Appl. No.: 15/577,817

(22) PCT Filed: May 31, 2016
(86) PCT No.: PCT/US16/35028

§ 371 Date: Nov. 29, 2017

Related U.S. Application Data
(60) Provisional application No. 62/168,217, filed on May 29, 2015.

(51) Int. Cl. B31F 1/28; B32B 3/12; B32B 3/28; B32B 5/08; B32B 5/26; B32B 7/04; B32B 15/12; B32B 15/14; B32B 27/10; B32B 27/12; B32B 27/36; B32B 29/00; B32B 29/08; D21H 13/26; D21H 13/40; D21H 13/50; D21H 27/34

(52) U.S. Cl. CPC B31F 1/289; B32B 2419/04; B32B 3/28; B32B 5/08; B32B 5/26; B32B 7/045; B32B 15/12; B32B 15/14; B32B 27/10; B32B 27/12; B32B 27/365; B32B 29/005; B32B 29/08; D21H 13/26; D21H 13/40; D21H 13/50; D21H 27/34; B32B 2255/02; B32B 2307/58; B32B 2262/106; B32B 2307/72; B32B 3/12

(57) ABSTRACT

A fibrous mat having high modulus reinforcing fibers can be used to make a corrugated paper. The corrugated paper can be used to make a honeycomb paper. Methods of making the honeycomb paper are discussed as well.

### BACKGROUND

This disclosure relates to honeycomb paper, methods of making, and articles comprising honeycomb paper.

Typically, honeycomb paper is composed of a corrugated core bonded to a facing sheet on each side. Honeycomb composites are made from a variety of materials, including a specially developed paper product that has the high strength and temperature capability required for demanding applications in aerospace and transportation, but also has some negative properties such as high moisture uptake, marginal flame performance, difficulty with adhesive bonding, long term stability, and lower than desired toughness. The industry has overcome most of those negative attributes, but flame performance is becoming more critical, as is the bonding process, which depends on epoxy, phenolic or other thermosetting polymer technologies. These tend to degrade the flame performance and increase the hygroscopic nature of the honeycomb.

Honeycomb is generally made from thin, high tensile strength corrugated paper that contains aramid fiber for example, by printing adhesive lines on the contact surface of the paper, then alternating the spacing of up to 2000 or more sheets and curing the adhesive under pressure and heat. The resulting paper stack can then be expanded, by pulling the top and bottom sheet of an individual block away from each other as in the opening of an accordion. This expands the paper stack into a block of a honeycomb pattern in which the glue lines define the attachment points between the sheets in the stack, and the spacing between adjacent pairs of glue lines defines the width of individual walls that make the honeycomb pattern. Air can be blown through the honeycomb to assist in expansion. The honeycomb then is heat set at high temperature and coated with a varnish or resin, which after curing stabilizes the structure and adds to its strength and stiffness. The honeycomb then is sliced into the desired thickness.

Printing the lines, heat setting, dipping and curing the adhesive, and dipping in varnish or resin, up to 32 times, followed each time by curing can add considerably to cost and time and require expensive printing equipment, and powerful hydraulics to open the honeycomb. An additional problem is encountered when the flat paper contains high modulus reinforcing fibers. As described above, expanding the honeycomb is generally an involved process even without high modulus reinforcing fibers in the paper. When high modulus fibers are contained in the flat sheets, the amount of energy needed to expand the block into an opened honeycomb structure can be too high for this method to be used productively.

There accordingly remains a need in the art for honeycomb paper containing high modulus reinforcing fibers and methods of manufacture thereof. It would be desirable for the paper to have at least one of improved moisture uptake, flame performance, adhesive bonding, long term stability, or toughness. It would further be desirable if the method was more efficient than the above-described process, and in particular did not depend on opening the corrugated paper.

### SUMMARY

Disclosed herein is corrugated paper comprising thermoplastic polymer and high modulus reinforcing fiber and honeycomb paper formed from the corrugated paper.

In some embodiments, the corrugated paper comprises a consolidated fibrous mat. The consolidated fibrous mat comprises 1 to 65 wt % of high modulus reinforcing fibers; and a continuous phase connecting the reinforcing fibers. The continuous phase connecting the reinforcing fibers comprises 35 to 99 wt % of a thermoplastic polymer fiber having a processing temperature at least 20° C. lower than the reinforcing fibers, 0 to 65 wt % of a high strength toughening fiber, and 0 to 10 wt % of a binder fiber having a melt temperature lower than the thermoplastic polymer fiber, wherein the wt % of each of the reinforcing fibers, the polymer, toughening fiber and the binder is based on the combined total weight of the reinforcing fibers, the thermoplastic polymer fibers, and the binder fiber.

In some embodiments, a corrugated paper comprises a thermoplastic polymer layer and a high modulus fiber cloth layer stacked and formed into corrugated paper.

In some embodiments a method of making a honeycomb paper comprises forming corrugated papers having high modulus reinforcing fibers, wherein the corrugated papers have high surfaces on each opposing side; applying an adhering agent to the high surfaces of at least one side of the corrugated papers; and stacking corrugated papers having an adhering agent to contact the high surfaces of adjacent papers with adhering agent disposed between the contacting high surfaces.

In some embodiments a method of making a honeycomb structure comprises: forming corrugated paper having high modulus reinforcing fibers, wherein the corrugated paper has high surfaces on each opposing side; applying an adhering agent to the high surfaces of at least one side of the corrugated paper; partially cutting the corrugated paper; and folding the corrugated paper having an adhering agent to contact the high surfaces with adhering agent with another high surface.

Articles are provided, comprising a honeycomb paper core bound to a protective layer, In some embodiments the protective layer comprises a polycarbonate copolymer film, glass fiber mat entrained with polyimide, flame retardant fabric, or sheet metal.

### BRIEF DESCRIPTION OF THE DRAWING

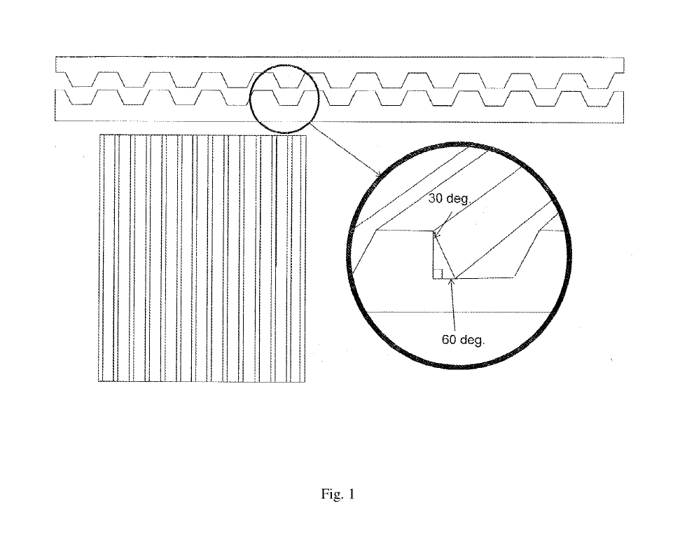

The above and other aspects, advantages and features of this disclosure will become more apparent by describing in further detail embodiments thereof with reference to the accompanying drawings, in which FIG. 1 shows a side and top plan view of a corrugated forming plate.

### DETAILED DESCRIPTION

A new process for preparing honeycomb paper and honeycomb structures is provided that overcomes the shortcomings of existing honeycomb papers discussed above. In some embodiments, the paper is produced by mixing several different chopped, thermoplastic polymer fibers that have melt temperatures differing sufficiently to permit consolidation, during which the primary polymer is pressed into a continuous film, while the reinforcing fiber polymer remains as un-melted fibers. The combination forms a very strong, reinforced film that can be bonded with another thermoplastic polymer film that does not degrade the flame performance.

A process that does not depend on the opening of the honeycomb is provided. In some embodiments, this process preforms corrugated papers, which are then coated with an adhering agent on the high surfaces, stacked to provide the honeycomb structure and heated under light pressure to bond the individual sheets together into honeycomb blocks. The resulting paper can be cut to thickness. This process eliminates the expansion process of prior art processes.

In another embodiment, the preformed corrugated paper is coated with an adhering agent on high surfaces on one or both sides, partially cut, and folded to form the finished product of any selected thickness. Since there is no stretching of the paper involved in either method, paper of uniformly light weight having high modulus fibers can be used to produce very lightweight, very stiff honeycomb. Another advantage is that the thickness of the honeycomb can be varied at will in the machine direction such as forming an airfoil shape. The cut-fold process makes this practical for carbon containing honeycomb.

When forming the corrugated paper an intermeshing roll process can be used to form the corrugated sheets on a continuous basis. The corrugation step has to allow for material to be drawn into the rolls without tearing or cutting has to be done at cross machine direction. Making corrugated paper can also be conducted by consolidation between release coated corrugation plates. The paper is formed in, for example, a furrow/hill pattern, such as shown in FIG. 1.

Adhering agents includes solvents and adhesives. Exemplary solvents include a solvent which is capable of at least partially dissolving one or more polymers which is part of the continuous phase connecting the reinforcing fibers. The solvent is applied and softens the continuous phase of the high surface of the corrugated sheet which then adheres to the continuous phase of the adjacent high surface with the application of pressure and optionally heat. Exemplary adhesives are selected based on the composition of the continuous phase and include epoxies, urethanes, acrylates and the like.

The specific compressive strength performance of the honeycomb at equivalent weight is improved. In addition, other properties, such as tensile strength, formability, moisture absorption, hydrolytic stability, and impact strength need to be maintained depending upon the end use.

Forming the corrugated paper can be done while the mat is either unconsolidated or heated to the processing point of the matrix polymer, such as polyetherimide for aerospace applications. In other applications, such as automotive, other matrix polymers can be used, such as polycarbonate, polyamide, polyphenylene, or polyethylene terephthalate. As long as the paper is at processing temperature, the individual high modulus fibers will be able to pull past each other as the matrix conforms to the mold and bend to at least several times their diameter without breaking. If the paper were below the processing temperature the fibers would not be able to slide past each other as they conform to surfaces of the mold which meet at an edge and lead to fiber breakage at bending points, or when trying to stretch the paper beyond about 1 to 1.5%.

The finished honeycomb, even with a proper surface layer should react in the same way, accommodating bending or stretching as long as it is warmed hot enough to permit the carbon fibers to slip past each other during forming. This behavior is the main reason for requiring a new process for producing the honeycomb. The stiffening effect of the high modulus reinforcing fiber would make it impossible to form a corrugated shape by opening a stack of papers bonded in the usual manner. The stiffening provided by the high modulus fibers increases the stiffness and strength without a weight penalty. Conversely, honeycomb of equal strength/stiffness should be possible at significantly lower density.

The term “fibers” as used herein includes a wide variety of structures having a single filament with an aspect ratio (length:diameter) of greater than 2, specifically greater than 5, greater than 10, or greater than 100. The term fibers also includes fibrets (very short (length less than 1 millimeter (mm)), fine (diameter less than 50 micrometer (μm)) fibrillated fibers that are highly branched and irregular resulting in high surface area, and fibrils, tiny threadlike elements of a fiber. The diameter of a fiber is indicated by its fiber number, which is generally reported as either dtex or dpf. The numerical value reported as “dtex” indicates the mass in grams per 10,000 meters of the fiber. The numerical value “dpf” represents the denier per fiber. The denier system of measurement is used on two and single filament fibers, and dpf=Total Denier/Quantity of Uniform Filaments. Some common denier-related calculations are as follows:

1 denier=1 gram per 9,000 meters=0.05 grams per 450 meters=0.111 milligrams per meter.

The term “fibrids”, as used herein, means very small, nongranular, fibrous or film-like particles with at least one of their three dimensions being of minor magnitude relative to the largest dimension, such that they are essentially two-dimensional particles, typically having a length of greater than 0 to less than 0.3 mm, and a width of greater than 0 to less than 0.3 mm and a depth of greater than 0 to less than 0.1 mm. In an exemplary embodiment the fibrids are on the order of 100 μm×100 μm×0.1 μm.

Fibrids are typically made by streaming a polymer solution into a coagulating bath of liquid that is immiscible with the solvent of the solution. The stream of polymer solution is subjected to strenuous shearing forces and turbulence as the polymer is coagulated. The fibrid material can be meta or para-aramid or blends thereof. More specifically, the fibrid is a para-aramid. Such aramid fibrids, before being dried, can be used wet and can be deposited as a binder physically entwined about the floc component of a paper.

The consolidated fibrous mat can contain 1 to 65 weight percent (wt %) of high modulus reinforcing fibers, for example 20 to 50 wt % (wt %), 20 to 45 wt %, 20 to 40 wt %, 20 to 35 wt. %, 20 to 30 wt. %, 20 to 25 wt %, 25 to 50 wt %, 25 to 40 wt %, 25 to 30 wt %, 30 to 50 wt %, 35 to 50 wt %, 40 to 50 wt %, 30 to 50 wt %, 30 to 45 wt %, or 30 to 40 wt % of reinforcing fibers.

The high modulus fibers, e.g., carbon fiber, can generally have a tensile modulus greater than or equal to 20, 30, 33, 42, 50, 55, 57, 63, 69, 78, 85 msi (million pounds per square inch). The tensile modulus can be less than or equal to 90 msi. The high modulus fibers are available as tow of various fiber counts, which can be chopped into staple fiber. Carbon Veil, also known as Carbon Tissue, is an ultralight, nonwoven carbon fiber fabric with random fiber orientation. Carbon fibers are available commercially, for example from Toho, Toray, Cytec, Zoltec, Mitsubishi, Aksa, SGL, and Ardima.

Generally, the relative amount of a given carbon fiber needed to achieve a given stiffness of the honeycomb is inversely related to the stiffness of the fiber; a larger amount of a lower modulus carbon fiber would be needed to achieve a given stiffness of the mat achieved using a higher modulus carbon fiber. At the same time, processing the fiber mix becomes more difficult as the modulus of the carbon fiber increases. In addition, the lower modulus carbon fibers are less costly than are high modulus carbon fibers. One skilled in the art will select a type and amount of fiber needed to produce the desired stiffness guided by these related factors.

The consolidated fibrous mat can contain 35 to 99 wt % of a polymer having a minimum processing temperature at least 20° C. lower than the reinforcing fibers, for example 50 to 70 wt %, 50 to 65 wt %, 50 to 60 wt %, 55 to 65 wt %, 55 to 60 wt %, 55 to 70 wt %, 60 to 70 wt %, 65 to 70 wt % of a polymer having a melt temperature at least 20° C. lower than the reinforcing fibers. Polymer fibers can be prepared from commercially available polymers, such as ULTEM polyetherimide, LEXAN polycarbonate from SABIC, LEXAN FST poly(carbonate-ester-siloxane) from SABIC, LEXAN EXL poly(carbonate-siloxane) from SABIC, SILTEM poly(etherimide-siloxane) from SABIC; VALOX from SABIC, XENOY polyesters from SABIC, polypropylene, or polyethylene. In some embodiments, the thermoplastic matrix comprises polyetherimide thermoplastic matrix, and blends with polyethylene terephthalate, polycarbonate, polyphenylene sulfide, polyphenylsulfone for high temperature applications and polyamides, including crystalline and amorphous, polycarbonates including copolymers, polyester, such as polyethylene terephthalate, polybutylene terephthalate, or blends, or polypropylene for lower temperature applications, or lower FST applications.

The consolidated fibrous mat can contain more than 0 to 65 wt % of a high strength toughening fiber, for example 5 to 65 wt %, 10 to 60 wt %, 25 to 55 wt %, 30 to 50 wt %, 35 to 40 wt %, 40 to 45 wt %, 20 to 65 wt %, 20 to 60 wt %, 20 to 55 wt. %, 20 to 50 wt. %, 20 to 45 wt %, 25 to 65 wt %, 25 to 60 wt %, 25 to 50 wt %, 30 to 60 wt %, 35 to 50 wt %, 35 to 40 wt %, 40 to 65 wt %, 40 to 55 wt %, or 40 to 50 wt % of a high strength toughening fiber.

Useful toughening fibers include as poly(p-phenylene-2,6-benzobisoxazole) (PBO), liquid crystal polymer, such as Vectran, and Nylon 6.6, 6, 11, 12, 4.6, etc., aramids, such as NOMEX (DuPont), CONEX (Teijin), ARAWIN (Toray), NEW STAR (Yantai Tayho), X-FIPER (SRO Group), KERMEL (Kermel); para aramids, such as KEVLAR (DuPont) and TWARON (Teijin), mixed aramids, TECHNORA (Teijin), plant derived fibers, such as BIOMID, flax, nettle, and hemp.

The consolidated fibrous mat can contain more than 0 wt % to 10 wt % of a binder having a melt temperature lower than the polymer, for example 3 to 10 wt %, 5 to 10 wt %, of a binder having a melt temperature lower than the polymer.

Useful binder fibers include polycarbonate copolymer, polyalkylene terephthalate, polyether ether ketone, polyamide, or a combination comprising at least one of the foregoing.

Various types of carbon fibers are known in the art, and can be classified according to their diameter, morphology, and degree of graphitization (morphology and degree of graphitization being interrelated). These characteristics are presently determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch. These types of fibers have a relatively lower degree of graphitization.

Carbon fibers having diameters from about 3 to about 2000 nanometers, and “tree-ring” or “fishbone” structures are presently grown from hydrocarbons in the vapor phase, in the presence of particulate metal catalysts at moderate temperatures, i.e., about 800 to about 1500° C. Carbon fibers are generally cylindrical, and have a hollow core. In the “tree-ring” structure a multiplicity of substantially graphitic sheets is coaxially arranged about the core, wherein the c-axis of each sheets is substantially perpendicular to the axis of the core. The interlayer correlation is generally low. In the “fishbone” structure, the fibers are characterized by graphite layers extending from the axis of the hollow core, as shown in EP 198 558 to Geus. A quantity of pyrolytically-deposited carbon can also be present on the exterior of the fiber.

Depending upon the precursor used to make the fiber, carbon fiber can be turbostratic or graphitic, or have a hybrid structure with both graphitic and turbostratic parts present. In turbostratic carbon fiber the sheets of carbon atoms are haphazardly folded, or crumpled, together. Carbon fibers derived from polyacrylonitrile (PAN) are turbostratic, whereas carbon fibers derived from mesophase pitch are graphitic after heat treatment at temperatures exceeding 2200° C. Turbostratic carbon fibers tend to have high tensile strength, whereas heat-treated mesophase-pitch-derived carbon fibers have high Young's modulus (i.e., high stiffness or resistance to extension under load) and high thermal conductivity.

A common method of manufacture involves heating the spun PAN filaments to approximately 300° C. in air, which breaks many of the hydrogen bonds and oxidizes the material. The oxidized PAN is then placed into a furnace having an inert atmosphere of a gas such as argon, and heated to approximately 2000° C., which induces graphitization of the material, changing the molecular bond structure. When heated in the correct conditions, these chains bond side-to-side (ladder polymers), forming narrow graphene sheets which eventually merge to form a single, columnar filament. The result is usually 93-95% carbon. Lower-quality fiber can be manufactured using pitch or rayon as the precursor instead of PAN. The carbon can become further enhanced, as high modulus, or high strength carbon, by heat treatment processes. Carbon heated in the range of 1500-2000° C. (carbonization) exhibits the highest tensile strength (820,000 psi, 5,650 MPa or N/mm²), while carbon fiber heated from 2500 to 3000° C. (graphitizing) exhibits a higher modulus of elasticity (77,000,000 psi or 531 GPa or 531 kN/mm²).Modulus

Exemplary carbon fibers include graphitic or partially graphitic carbon fibers having diameters of about 3.5 to about 500 nanometers, with diameters of about 3.5 to about 70 nanometers being preferred, and diameters of about 3.5 to about 50 nanometers being more preferred. Representative carbon fibers are the vapor grown carbon fibers described in, for example, U.S. Pat. Nos. 4,565,684 and 5,024,818 to Tibbetts et al.; U.S. Pat. No. 4,572,813 to Arakawa; U.S. Pat. Nos. 4,663,230 and 5,165,909 to Tennent; U.S. Pat. No. 4,816,289 to Komatsu et al.; U.S. Pat. No. 4,876,078 to Arakawa et al.; U.S. Pat. No. 5,589,152 to Tennent et al.; and 5,591,382 to Nahass et al.

Other high modulus fibers for use as reinforcing fibers include silicon carbide, tungsten carbide, boron, and organic fibers such as nettle or Biomid™. In some embodiments, the reinforcing fiber can have a tensile modulus above 15 msi and below 55 msi.

Polyetherimides comprise more than 1, for example 2 to 1000, or 5 to 500, or 10 to 100 structural units of formula (1)

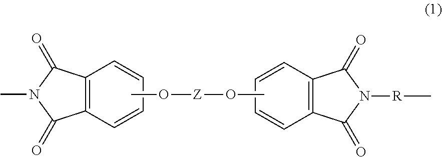

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the formulas (2)

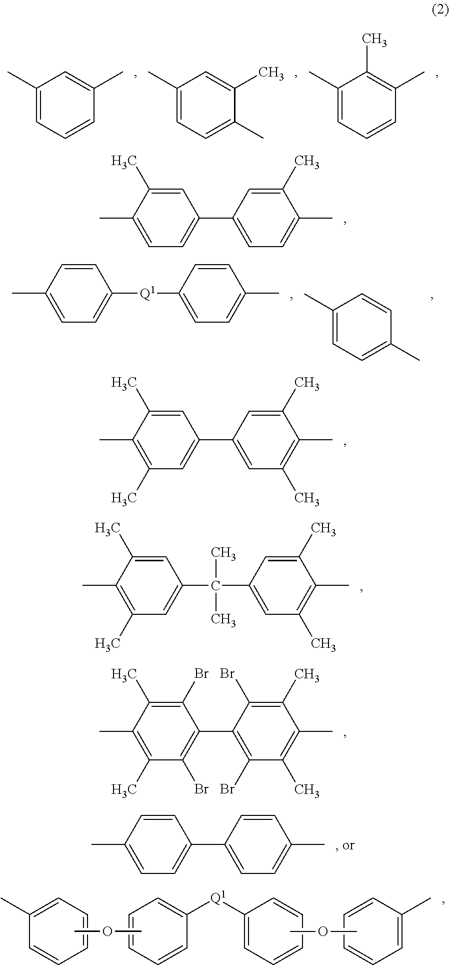

wherein Q¹ is —O—, —S—, —C(O)—, —SO₂—, —SO—, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent of the R groups contain sulfone groups, and in other embodiments no R groups contain sulfone groups.

Further in formula (1), the divalent bonds of the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

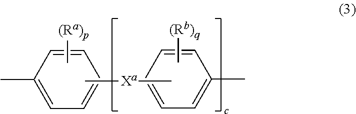

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

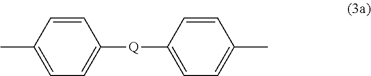

wherein Q is —O—, —S—, —SO₂—, —SO—, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (1), R is m-phenylene, p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O wherein Z is a divalent group of formula (3a) and Q is 2,2-isopropylidene. Alternatively, the polyetherimide can be a copolymer comprising additional structural polyetherimide units of formula (1) wherein at least 50 mole percent (mol %) of the R groups are bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety.

In some embodiments, the polyetherimide is a copolymer that optionally comprises additional structural imide units that are not polyetherimide units, for example imide units of formula (4)

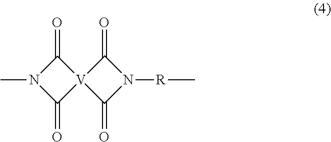

wherein R is as described in formula (1) and each V is the same or different, and is a substituted or unsubstituted C₆₋₂₀ aromatic hydrocarbon group, for example a tetravalent linker of the formulas

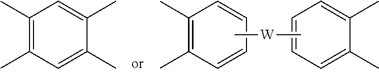

wherein W is a single bond, —S—, —SO₂—, —SO—, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide can be prepared by any of the methods known to those skilled in the art, including the reaction of an aromatic bis(ether anhydride) of formula (5) or a chemical equivalent thereof, with an organic diamine of formula (6)

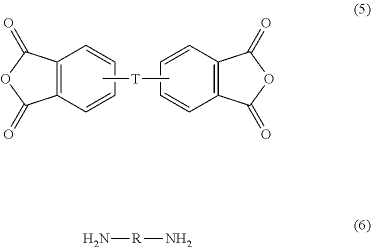

wherein T and R are defined as described above. Copolymers of the polyetherimides can be manufactured using a combination of an aromatic bis(ether anhydride) of formula (5) and an additional is(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of organic diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1,3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C1-4 alkylated or poly(C1-4)alkylated derivatives of any of the foregoing can be used, for example a polymethylated 1,6-hexanediamine. Combinations of these compounds can also be used. In some embodiments the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

In some embodiments, the polyetherimide comprises less than 50 ppm amine end groups. In other instances the polymer will also have less than 1 ppm of free, unpolymerized bisphenol A (BPA).

The polyetherimides can have low levels of residual volatile species, such as residual solvent and/or water. In some embodiments, the polyetherimides have a residual volatile species concentration of less than 1,000 parts by weight per million parts by weight (ppm), or, more specifically, less than 500 ppm, or, more specifically, less than 300 ppm, or, even more specifically, less than 100 ppm. In some embodiments, the composition has a residual volatile species concentration of less than 1,000 parts by weight per million parts by weight (ppm), or, more specifically, less than 500 ppm, or, more specifically, less than 300 ppm, or, even more specifically, less than 100 ppm.

Examples of residual volatile species are halogenated aromatic compounds such as chlorobenzene, dichlorobenzene, trichlorobenzene, aprotic polar solvents such as dimethyl formamide (DMF), N-methyl pyrrolidinone (NMP), dimethyl sulfoxide (DMSO), diaryl sulfones, sulfolane, pyridine, phenol, veratrole, anisole, cresols, xylenols, dichloro ethanes, tetra chloro ethanes, pyridine and mixtures thereof.

Low levels of residual volatile species in the final polymer product can be achieved by known methods, for example, by devolatilization or distillation. In some embodiments the bulk of any solvent can be removed and any residual volatile species can be removed from the polymer product by devolatilization or distillation, optionally at reduced pressure. In other embodiments the polymerization reaction is taken to some desired level of completion in solvent and then the polymerization is essentially completed and most remaining water is removed during a devolatilization step following the initial reaction in solution. Apparatuses to devolatilize the polymer mixture and reduce solvent and other volatile species to the low levels needed for good melt processability are generally capable of high temperature heating under vacuum with the ability to rapidly generate high surface area to facilitate removal of the volatile species. The mixing portions of such apparatuses are generally capable of supplying sufficient power to pump, agitate, and stir the high temperature, polyetherimide melt which can be very viscous. Suitable devolatilization apparatuses include, but are not limited to, wiped films evaporators, for example those made by the LUWA Company and devolatilizing extruders, especially twin screw extruders with multiple venting sections, for example those made by the Werner Pfleiderer Company or Welding Engineers.

In some embodiments the polyetherimide has a glass transition temperature of 200 to 280° C.

It is often useful to melt filter the polyetherimide using known melt filtering techniques to remove foreign material, carbonized particles, cross-linked resin, or similar impurities. Melt filtering can occur during initial polymer isolation or in a subsequent step. The polyetherimide can be melt filtered in the extrusion operation. Melt filtering can be performed using a filter with pore size sufficient to remove particles with a dimension of greater than or equal to 100 micrometers or with a pore size sufficient to remove particles with a dimension of greater than or equal to 40 micrometers.

The polyetherimide composition can optionally comprise additives such as UV absorbers; stabilizers such as light stabilizers and others, lubricants, plasticizers, pigments, dyes, colorants, anti-static agents, metal deactivators, and combinations comprising at least one of the foregoing additives. In some embodiments, the additive can include a combination of a mold release agent and a stabilizer comprising phosphite stabilizers, phosphonite stabilizers, hindered phenol stabilizers, and combinations comprising at least one of the foregoing stabilizers. In some embodiments, a phosphorus-containing stabilizer is used.

Antioxidants can be compounds such as phosphites, phosphonites, hindered phenols, or combinations comprising at least one of the foregoing antioxidants. Phosphorus-containing stabilizers including triaryl phosphites and aryl phosphonates are of note as useful additives. Difunctional phosphorus containing compounds can also be employed. In some embodiments, to prevent loss of the stabilizer during melt mixing or subsequent melt forming processes such as injection molding, the phosphorus containing stabilizers with a molecular weight greater than or equal to 300 Dalton, but less than or equal to 5,000 Dalton, are useful. The additive can comprise hindered phenols with molecular weight over 500 Dalton. Phosphorus-containing stabilizers can be present in the composition at 0.01 to 3.0% or to 1.0% by weight of the total composition.

The fibrous substrates further comprise fibers composed of materials other than the polyetherimide. The other fibers can be high strength, heat resistant organic fibers such as aromatic polyamides (including homopolymers and copolymers), aromatic polyester fibers (including homopolymers and copolymers), and aromatic heterocyclic fibers (including homopolymers and copolymers). Such fibers can have a strength of about 10 g/D to about 50 g/D, specifically 15 g/D to 50 g/D, and a pyrolysis temperature of greater than 300° C., specifically greater than about 350° C. As used herein, an “aromatic” polymer contains at least 85 mole % of the polymer linkages (e.g., —CO—NH—) attached directly to two aromatic rings.

In some embodiments, the polyetherimides include a polyetherimide thermoplastic composition, comprising: (a) a polyetherimide, and (b) a phosphorus-containing stabilizer, in an amount that is effective to increase the melt stability of the polyetherimide, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of 20° C. per minute under an inert atmosphere. In some embodiments, the phosphorous-containing stabilizer has a formula P—Rₐ, where R′ is independently H, alkyl, alkoxy, aryl, aryloxy, or oxy substituent and a is 3 or 4. Examples of such suitable stabilized polyetherimides can be found in U.S. Pat. No. 6,001,957, incorporated herein in its entirety.

Aromatic polyamide fibers are also known as aramid fibers, which can be broadly categorized as para-aramid fibers or meta-aramid fibers. Illustrative examples of para-aramid fibers include poly(p-phenylene terephthalamide) fibers (produced, e.g., by E. I. Du Pont de Nemours and Company and Du Pont-Toray Co., Ltd. under the trademark KEVLAR®), p-phenylene terephthalamide/p-phenylene 3,4′-diphenylene ether terephthalamide copolymer fibers (produced by Teijin Ltd. under the trade name TECHNORA), (produced by Teijin Ltd. under the trade name designation TWARON), or combinations comprising at least one of the foregoing aramids. Illustrative examples of meta-aramid fibers include poly(m-phenylene terephthalamide) fibers (produced, e.g., by E. I. Du Pont de Nemours and Company under the trademark NOMEX®). Such aramid fibers can be produced by methods known to one skilled in the art.

Wholly aromatic polyester fibers include liquid crystal polyesters. Illustrative examples of such wholly aromatic polyester fibers include self-condensed polymers of p-hydroxybenzoic acid, polyesters comprising repeat units derived from terephthalic acid and hydroquinone, polyester fibers comprising repeat units derived from p-hydroxybenzoic acid and 6-hydroxy-2-naphthoic acid, or combinations thereof. A specific wholly aromatic liquid crystal polyester fiber is produced by the polycondensation of 4-hydroxybenzoic acid and 6-hydroxynaphthalene-2-carboxylic acid (commercially available from Kuraray Co., Ltd. under the trade name designation VECTRAN). Such wholly aromatic polyester fibers can be produced by any methods known to one skilled in the art.

Illustrative examples of aromatic heterocyclic fibers include poly(p-phenylene benzobisthiazole) fibers, poly(p-phenylene benzobisoxazole) fibers (PBO), polybenzimidazole fibers, or combinations comprising at least one of the foregoing fibers. PBO fibers are commercially available from Toyobo Co., Ltd. under the trade name designation ZYLON.

In a specific embodiment, the aramid fibers are para-type homopolymers, for example poly(p-phenylene terephthalamide) fibers.

The fibrous substrate can also comprise polycarbonate fibers. “Polycarbonate” as used herein means a polymer or copolymer having repeating structural carbonate units of the formula

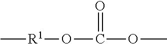

wherein at least 60 percent of the total number of R¹ groups are aromatic, or each R¹ contains at least one C₆₋₃₀ aromatic group. Polycarbonates and their methods of manufacture are known in the art, being described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxy-3-methylphenyl)-3,3,5-trimethylcyclohexane, or a combination comprising at least one of the foregoing bisphenol compounds can also be used. In a specific embodiment, the polycarbonate is a homopolymer derived from BPA; a copolymer derived from BPA and another bisphenol or dihydroxy aromatic compound such as resorcinol; or a copolymer derived from BPA and optionally another bisphenol or dihydroxyaromatic compound, and further comprising non-carbonate units, for example aromatic ester units such as resorcinol terephthalate or isophthalate, aromatic-aliphatic ester units based on C₆₋₂₀ aliphatic diacids, polysiloxane units such as polydimethylsiloxane units, or a combination comprising at least one of the foregoing. “Polycarbonate” as used herein includes homopolycarbonates (wherein each R¹ in the polymer is the same), copolymers comprising different R¹ moieties in the carbonate units (referred to herein as “copolycarbonates”), copolymers comprising carbonate units and other types of polymer units, such as ester units, and combinations comprising homopolycarbonate and/or copolycarbonate. As used herein, a “combination” is inclusive of blends, mixtures, alloys, reaction products, and the like.

A specific polycarbonate copolymer is a poly(carbonate-ester). Such copolymers further contain, in addition to recurring carbonate units (1), repeating units (7)

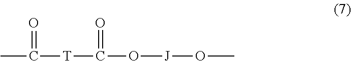

wherein J is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T divalent group derived from a dicarboxylic acid, and can be, for example, a C₂₋₁₀ alkylene group, a C₆₋₂₀ alicyclic group, a C₆₋₂₀ alkyl aromatic group, or a C₆₋₂₀ aromatic group. Poly(carbonate-ester)s containing a combination of different T and/or J groups can be used. The poly(carbonate-ester)s can be branched or linear.

In some embodiments, J is a C₂₋₃₀ alkylene group having a straight chain, branched chain, or cyclic (including polycyclic) structure. In another embodiment, J is derived from an aromatic dihydroxy compound (3). In another embodiment, J is derived from an aromatic dihydroxy compound (4). In another embodiment, J is derived from an aromatic dihydroxy compound (6).

Exemplary aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, or a combination comprising at least one of the foregoing acids. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, cyclohexane dicarboxylic acid, or a combination comprising at least one of the foregoing acids. A specific dicarboxylic acid comprises a combination of isophthalic acid and terephthalic acid wherein the weight ratio of isophthalic acid to terephthalic acid is about 91:9 to about 2:98. In another specific embodiment, J is a C₂₋₆ alkylene group and T is p-phenylene, m-phenylene, naphthalene, a divalent cycloaliphatic group, or a combination comprising at least one of the foregoing.

The molar ratio of carbonate units to ester units in the copolymers can vary broadly, for example 1:99 to 99:1, specifically 10:90 to 90:10, more specifically 25:75 to 75:25, depending on the desired properties of the final composition.

A specific embodiment of a poly(carbonate-ester) (8) comprises recurring aromatic carbonate and aromatic ester units

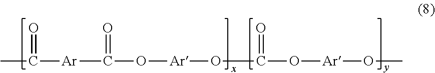

wherein Ar is divalent aromatic residue of a dicarboxylic acid or combination of dicarboxylic acids, and Ar′ is a divalent aromatic residue of a bisphenol (3) or a dihydric compound (6). Ar is thus an aryl group, and is more specifically the residue of isophthalic acid (9a), terephthalic acid (9b),

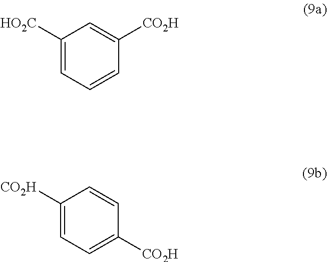 [SMILES: O=C(O)c1cccc(C(=O)O)c1 ; O=C(O)c1ccc(C(=O)O)cc1]

or a combination comprising at least one of the foregoing. Ar′ can be polycyclic, e.g., a residue of biphenol or bisphenol A, or monocyclic, e.g., the residue of hydroquinone or resorcinol.

Further in the poly(carbonate-ester) (8), x and y represent the respective parts by weight of the aromatic ester units and the aromatic carbonate units based on 100 parts total weight of the copolymer. Specifically, x, the aromatic ester content, is 20 to 100, specifically 30 to 95, still more specifically 50 to 95 parts by weight, and y, the carbonate content, is more than zero to 80, specifically 5 to 70, still more specifically 5 to 50 parts by weight. In general, any aromatic dicarboxylic acid used in the preparation of polyesters can be utilized in the preparation of poly(carbonate-ester)s (8) but terephthalic acid alone can be used, or mixtures thereof with isophthalic acid wherein the weight ratio of terephthalic acid to isophthalic acid is in the range of 5:95 to 95:5. In this embodiment, the poly(carbonate-ester)s (8) can be derived from reaction of bisphenol-A and phosgene with iso- and terephthaloyl chloride, and can have an intrinsic viscosity of 0.5 to 0.65 deciliters per gram (measured in methylene chloride at a temperature of 25° C.). Copolymers of formula (8) comprising 35 to 45 wt % of carbonate units and 55 to 65 wt % of ester units, wherein the ester units have a molar ratio of isophthalate to terephthalate of 45:55 to 55:45 are often referred to as poly(carbonate-ester)s (PCE) and copolymers comprising 15 to 25 wt % of carbonate units and 75 to 85 wt % of ester units having a molar ratio of isophthalate to terephthalate from 98:2 to 88:12 are often referred to as poly(phthalate-carbonate)s (PPC).

In another specific embodiment, the poly(carbonate-ester) comprises carbonate units (1) derived from a bisphenol compound (3), and ester units derived from an aromatic dicarboxylic acid and dihydroxy compound (6). Specifically, the ester units are arylate ester units (10)

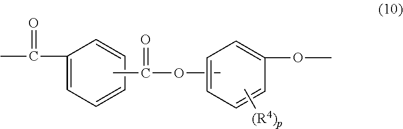

wherein each R⁴ is independently a halogen or a C₁₋₄ alkyl, and p is 0 to 3. The arylate ester units can be derived from the reaction of a mixture of terephthalic acid and isophthalic acid or chemical equivalents thereof with compounds such as 5-methyl resorcinol, 5-ethyl resorcinol, 5-propyl resorcinol, 5-butyl resorcinol, 5-t-butyl resorcinol, 2,4,5-trifluoro resorcinol, 2,4,6-trifluoro resorcinol, 4,5,6-trifluoro resorcinol, 2,4,5-tribromo resorcinol, 2,4,6-tribromo resorcinol, 4,5,6-tribromo resorcinol, catechol, hydroquinone, 2-methyl hydroquinone, 2-ethyl hydroquinone, 2-propyl hydroquinone, 2-butyl hydroquinone, 2-t-butyl hydroquinone, 2,3,5-trimethyl hydroquinone, 2,3,5-tri-t-butyl hydroquinone, 2,3,5-trifluoro hydroquinone, 2,3,5-tribromo hydroquinone, or a combination comprising at least one of the foregoing compounds. The ester units can be poly(isophthalate-terephthalate-resorcinol ester) units, also known as “ITR” esters.

The poly(carbonate-ester)s comprising ester units (10) can comprise, based on the total weight of the copolymer, 1 to less than 100 wt %, 10 to less than 100 wt %, 20 to less than 100 wt %, or 40 to less than 100 wt % of carbonate units (1) derived from a bisphenol compound (3), and greater than 0 to 99 wt %, greater than 0 to 90 wt %, greater than 0 to 80 wt %, or greater than 0 to 60 wt % of ester units derived from an aromatic dicarboxylic acid and dihydroxy compound (6). A specific poly(carbonate-ester) comprising arylate ester units (9) is a poly(bisphenol-A carbonate)-co-poly(isophthalate-terephthalate-resorcinol ester).

In another specific embodiment, the poly(carbonate-ester) contains carbonate units (1) derived from a combination of a bisphenol (3) and a dihydroxy compound (6), and arylate ester units (9). The molar ratio of carbonate units derived from dihydroxy compound (3) to carbonate units derived from dihydroxy compound (6) can be 1:99 to 99:1. A specific poly(carbonate-ester) of this type is a poly(bisphenol-A carbonate)-co-(resorcinol carbonate)-co(isophthalate-terephthalate-resorcinol ester).

Polycarbonates, including polycarbonate-esters, can be manufactured by processes such as interfacial polymerization and melt polymerization as is known in the art, and described in the above-referenced applications. All types of polycarbonate end groups are contemplated as being useful in the polycarbonate composition, provided that such end groups do not significantly adversely affect desired properties of the compositions. A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates. The polyester-polycarbonates in particular can also be prepared by interfacial polymerization as described above with respect to polycarbonates generally. Rather than utilizing the dicarboxylic acid or diol per se, the reactive derivatives of the acid or diol, such as the corresponding acid halides, in particular the acid dichlorides and the acid dibromides can be used. Thus, for example instead of using isophthalic acid, terephthalic acid, or a combination comprising at least one of the foregoing acids, isophthaloyl dichloride, terephthaloyl dichloride, or a combination of the foregoing dichlorides can be used.

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight of 10,000 to 200,000 Daltons, specifically 20,000 to 100,000 Daltons, as measured by gel permeation chromatography (GPC), using a cross-linked styrene-divinylbenzene column and calibrated to polycarbonate references. GPC samples are prepared at a concentration of 1 mg per ml, and are eluted at a flow rate of 1.5 ml per minute. Combinations of polycarbonates of different flow properties can be used to achieve the overall desired flow property. In some embodiments, polycarbonates are based on bisphenol A, in which each of A³ and A⁴ is p-phenylene and Y² is isopropylidene. The weight average molecular weight of the polycarbonate can be 5,000 to 100,000 Daltons, or, more specifically 10,000 to 65,000 Daltons, or, even more specifically, 15,000 to 35,000 Daltons as determined by GPC as described above.

The polyester-polycarbonates in particular are generally of high molecular weight and have an intrinsic viscosity, as determined in chloroform at 25° C. of 0.3 to 1.5 dl/gm, and more specifically 0.45 to 1.0 dl/gm. These polyester-polycarbonates can be branched or unbranched and generally will have a weight average molecular weight of 10,000 to 200,000, more specifically 20,000 to 100,000 as measured by gel permeation chromatography.

Polycarbonates containing poly(carbonate-siloxane) blocks can be used. The polysiloxane blocks are polydiorganosiloxane, comprising repeating diorganosiloxane units as in formula (10)

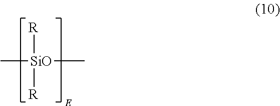

wherein each R is independently the same or different C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination comprising at least one of the foregoing halogens. In some embodiments, where a transparent polysiloxane-polycarbonate is desired, R is unsubstituted by halogen. Combinations of the foregoing R groups can be used in the same copolymer.

The value of E in formula (10) can vary widely depending on the type and relative amount of each component in the thermoplastic composition, the desired properties of the composition, and like considerations. Generally, E has an average value of 2 to about 1,000, specifically about 2 to about 500, more specifically about 5 to about 100. In some embodiments, E has an average value of about 10 to about 75, and in still another embodiment, E has an average value of about 40 to about 60. Where E is of a lower value, e.g., less than about 40, it can be desirable to use a relatively larger amount of the polycarbonate-polysiloxane copolymer. Conversely, where E is of a higher value, e.g., greater than about 40, a relatively lower amount of the polycarbonate-polysiloxane copolymer can be used.

A combination of a first and a second (or more) poly(carbonate-siloxane) copolymers can be used, wherein the average value of E of the first copolymer is less than the average value of E of the second copolymer.

In some embodiments, the polydiorganosiloxane blocks are of formula (11)

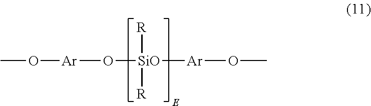

wherein E is as defined above; each R can be the same or different, and is as defined above; and Ar can be the same or different, and is a substituted or unsubstituted C₆-C₃₀ arylene group, wherein the bonds are directly connected to an aromatic moiety. Ar groups in formula (11) can be derived from a C₆-C₃₀ dihydroxyarylene compound, for example a dihydroxyarylene compound of formula (3) or (6) above. Exemplary dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations comprising at least one of the foregoing dihydroxy compounds can also be used.

In another embodiment, polydiorganosiloxane blocks are of formula (12)

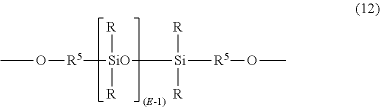

wherein R and E are as described above, and each R⁵ is independently a divalent C₁-C₃₀ organic group, and wherein the polymerized polysiloxane unit is the reaction residue of its corresponding dihydroxy compound.

In a specific embodiment, the polydiorganosiloxane blocks are of formula (13)

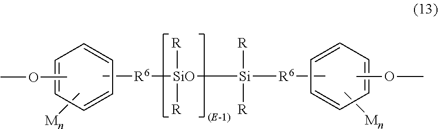

wherein R and E are as defined above. R⁶ in formula (13) is a divalent C₂-C₈ aliphatic group. Each M in formula (14) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

In some embodiments, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R² is a divalent C₁-C₃ aliphatic group, and R is methyl.

Blocks of formula (13) can be derived from the corresponding dihydroxy polydiorganosiloxane (14)

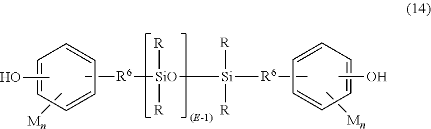

wherein R, E, M, R⁶, and n are as described above.

The poly(carbonate-siloxane)s can comprise 50 to 99 wt % of carbonate units and 1 to 50 wt % siloxane units. Within this range, the poly(carbonate-siloxane)s can comprise 70 to 98 wt %, more specifically 75 to 97 wt % of carbonate units and 2 to 30 wt %, more specifically 3 to 25 wt % siloxane units.

The poly(carbonate-siloxane)s can have a weight average molecular weight of 2,000 to 100,000 Daltons, specifically 5,000 to 50,000 Daltons as measured by gel permeation chromatography using a cross-linked styrene-divinyl benzene column, at a sample concentration of 1 milligram per milliliter, and as calibrated with polycarbonate standards.

The poly(carbonate-siloxane) can have a melt volume flow rate, measured at 300° C./1.2 kg, of 1 to 50 cubic centimeters per 10 minutes (cc/10 min), specifically 2 to 30 cc/10 min. Mixtures of polyorganosiloxane-polycarbonates of different flow properties can be used to achieve the overall desired flow property.

The foregoing polycarbonates can be used alone or in combination, for example a combination of a homopolycarbonate and at least one poly(carbonate-ester), or a combination of two or more poly(carbonate-ester)s. Blends of different poly(carbonate-ester)s can be used in these compositions.

A specific polycarbonate copolymer is Lexan FST 9705, a poly(carbonate-resorcinol-siloxane) polymer available from SABIC Innovative Plastics.

Other polymers such as amorphous PET (polyethylene terephthalate) can be substituted for polycarbonate polymer if flame performance is not an issue. Other high temperature polymers such as PEEK (polyether ether ketone) polymer can be used when available as fine fiber. High temperature polyimides could be used as the reinforcing fiber in combination with liquid crystal polymer as the continuous phase film former to make a much higher temperature capable honeycomb paper with very high resistance to jet fuels. In such some embodiments, the un-melted fibers, are referred to as reinforcing fibers within the structures here described regardless of whether the fibers, such as polyimide fibers, act as reinforcing fibers in the composition.

In some embodiments, the polymers of the fibrous substrate could also be combined during a fiber extrusion process known as bi-component fiber extrusion. In such embodiments, a first polymer can be melt spun along with a second polymer to form a core/sheath fiber according to known methods. Methods for making bi-component and multicomponent fibers are well known and need not be described here in detail. For example, U.S. Pat. No. 5,227,109, which is hereby incorporated by reference, describes forming bi-component fibers in a sheath-core relationship in a spinning pack that incorporates a plurality of adjacent plates that define selected flow paths therein for a sheath component and a core component to direct the respective components into the sheath-core relationship. In addition, more complex multicomponent fiber morphologies can be considered within the term core sheath as used herein, such as disclosed in U.S. Pat. No. 5,458,972, which is hereby incorporated by reference, and describes a method of producing a multicomponent trilobal fiber using a trilobal capillary defining three legs, three apexes and an axial center, by directing a first molten polymer composition to the axial center and presenting a second molten polymer composition to at least one of the apexes. The fiber produced has a trilobal core defining an outer core surface and a sheath abutting at least about one-third of the outer core surface.

In various embodiments, the first polymer can be the core fiber while the second polymer is the sheath fiber, or the second polymer can be the core fiber while the first polymer is the sheath fiber. The first and second polymer can be any of the polymers described above in the context of the useful fibers. In some embodiments, polyetherimide would be the core and polycarbonate would be the outer layer. The embodiment would make bonding the fibers in the mat more uniform. In another embodiment, the liquid crystal polymer would be the core and the polyetherimide the outer layer. This embodiment would improve the uniformity of dispersion of the materials over a given area in construction of the paper. This embodiment could also allow for the production of finer fiber, which is critical for uniform dispersion in very thin products such as this.

The fibrous mat can be made using known paper making techniques, such as on cylinder or fourdrinier paper making machines. In general, fibers are chopped and refined to obtain the proper fiber size. The synthetic fibers and binder are added to water to form a mixture of fibers and water. The mixture then is screened to drain the water from the mixture to form a sheet of paper. The screen tends to orient the fibers in the direction in which the sheet is moving, which is referred to as the machine direction. Consequently, the resulting insulation paper has a greater tensile strength in the machine direction than in the perpendicular direction, which is referred to as the cross direction. The sheet of paper is fed from the screen onto rollers and through other processing equipment that removes the water in the paper.

The fibrous mat can be prepared at an aereal density of 5 to 200 GSM (grams per square meter), specifically 30 to 120 GSM, and more specifically 40 to 80 GSM. In some embodiments, the density of the fibrous mat is 40 to 80 GSM and the mat has sufficient porosity to allow penetration by varnish which sets to reinforce the shape of the final honeycomb paper. In another embodiment, the density of the mat is 80 to 120 GSM, the substrate is not as porous, and no varnish is needed for added strength. In another embodiment the consolidated fibrous mat has a density of 80 GSM.

Methods of measuring porosity are known to those skilled in the art, such as ISO 5636-5:2003. In this technique, the Gurley second or Gurley unit is a unit describing the number of seconds required for 100 cubic centimeters (1 deciliter) of air to pass through 1.0 square inch of a given material at a pressure differential of 4.88 inches of water (0.188 psi), which is also expressed as square inch seconds per deciliter (s·in²/dl). In SI units, 1 s·in²/dl=6.4516 seconds per meter column of air (s/m). In another aspect, the honeycomb paper may have a porosity of greater than 20 to less than 120 s·in²/dl (Gurley second).

The consolidated mat can be prepared in any thickness suitable to the intended application. In general, consistent thickness is desirable. In some embodiments, the average thickness of the mat is more than 0 to less than 2 millimeters. In other embodiments the thickness is more than 0 to less than 1 millimeter. In other embodiments the thickness is more than 0 to 800 μm; 10 to 500 μm; 20 to less than 300 μm.

In some embodiments, the honeycomb paper is combined with a protective layer bound to a surface of the honeycomb core to form an article useful in structural applications. Usually, a protective layer is bound to both sides of the honeycomb core. The protective layer can be any generally planar material which can be bound to the honeycomb core. For example the protective layer can be polycarbonate copolymer film, glass fiber mat entrained with polyimide, liquid crystal polymer mat, carbon fiber fabric, flame retardant fabric, sheet metal or non-woven reinforced polymer sheet, or a combination thereof.

These honeycomb structural panels are particularly useful in applications where low weight is advantageous for example in transportation, furniture, pallets, and containers. In some embodiments these panels can be formed into articles which can serve as interior and exterior surfaces such as floors, walls, ceilings, doors, lids, covers, seats, tables, and counters for aircraft, rail, marine, automotive, and construction applications.

The following Examples are illustrative, and non-limiting.

### EXAMPLES

The materials used in the following Examples are summarized in Table 1.

TABLE 1

| Material | Properties | Supplier |
|---|---|---|
| PEI Film 5 micron | ULTEM 1000 | SABIC |
| Carbon Veil 2 gsm | Modulus 240 GPa | TFP |
| Aramid Veil 8 gsm | Nonwoven | TFP |
| Corrugation Plates | Custom, as shown in FIG. 1 | Moldmaster Inc. |
| Release Coating | McLube 1031 | McGee Industries |

Samples were prepared as 12 inch×14 inch×0.002 inch mats (30.5 centimeters (cm)×35.5 cm×0.005 cm), by assembling lightweight carbon and aramid veil and 5 micrometer (μm) ULTEM film in the following order:

PEI Film/Carbon Veil/PEI film/Aramid Veil/PEI Film/Carbon Veil/PEI Film=50 μm.

The formulation was consolidated between release coated corrugation plates with preheating to 650 degrees F. (343 degrees C.) at 50 pounds per square inch (psi) (345 kiloPascals (kPa)) for 3 minutes then 500 psi (3447 kPa) for 5 minutes followed by cooling to room temperature to form a relatively uniform paper of about 50 GSM. The formed paper was cut into uniform strips of ¼ inch, ½ inch and 1 inch (0.6 cm, 1.27 cm, and 2.5 cm) and laminated into small samples of ¼ inch, ½ inch and 1 inch (0.6 cm, 1.27 cm, and 2.5 cm) thick honeycomb. The final product exhibited a greenish grey color with noticeably higher compressive strength than standard honeycomb paper.

The invention is further described in the following non-limiting embodiments.

### Embodiment 1

Corrugated paper comprises a consolidated fibrous mat. The consolidated fibrous mat comprises 1 to 65 wt % of high modulus reinforcing fibers; and a continuous phase connecting the reinforcing fibers. The continuous phase comprises 35 to 99 wt % of a thermoplastic polymer fiber having a processing temperature at least 20° C. lower than the reinforcing fibers, 0 to 65 wt % of a high strength toughening fiber, and 0 to 10 wt % of a binder fiber having a melt temperature lower than the thermoplastic polymer, wherein the wt % of each of the reinforcing fibers, the thermoplastic polymer fiber, toughening fiber and the binder fiber is based on the combined total weight of the reinforcing fibers, the thermoplastic polymer fibers, and the binder fiber.

### Embodiment 2

The corrugated paper of Embodiment 1, wherein the high modulus reinforcing fibers comprise carbon fibers having a modulus greater than or equal to 20 msi and below 90 msi, glass fibers, basalt fibers, alumina, or a combination comprising at least one of the foregoing fibers, the thermoplastic polymer fiber comprises a polyetherimide, polyetherimide sulfone, polyphenylene sulfide, or a combination thereof. the high strength toughening fiber comprising poly(p-phenylene-2,6-benzobisoxazole), liquid crystal polymer, nylon, aramids, para aramids, mixed aramids, plant derived fibers, or a combination thereof, and the binder fiber comprises polycarbonate copolymer, polyalkylene terephthalate, polyether ether ketone, polyamide, or a combination thereof.

### Embodiment 3

Corrugated paper comprising a thermoplastic polymer layer and a layer of high modulus fiber cloth layer stacked and formed into corrugated sheets.

### Embodiment 4

The corrugated paper of Embodiment 3, wherein the thermoplastic polymer layer comprises a consolidated fibrous mat comprising 1 to 65 wt % of high modulus reinforcing fibers; and a continuous phase connecting the reinforcing fibers. The continuous phase comprises 35 to 99 wt % of a thermoplastic polymer fiber having a processing temperature at least 20° C. lower than the reinforcing fibers, 0 to 65 wt % of a high strength toughening fiber, and 0 to 10 wt % of a binder fiber having a melt temperature lower than the polymer, wherein the wt % of each of the reinforcing fibers, the thermoplastic polymer fiber, toughening fiber and binder fiber is based on the combined total weight of the reinforcing fibers, the thermoplastic polymer fibers, and the binder fiber.

### Embodiment 5

The corrugated paper of Embodiment 4, wherein the high modulus reinforcing fibers comprise carbon fibers having a modulus above 20 msi and below 90 msi, glass fibers, basalt fibers, alumina, or a combination comprising at least one of the foregoing fibers, the thermoplastic polymer fiber comprises a polyetherimide, polyetherimide sulfone, polyphenylene sulfide, or a combination thereof, the high strength toughening fiber comprising poly(p-phenylene-2,6-benzobisoxazole), liquid crystal polymer, nylon, aramids, para aramids, mixed aramids, plant derived fibers, or a combination thereof; and the binder fiber comprises polycarbonate copolymer, polyalkylene terephthalate, polyether ether ketone, polyamide, or a combination thereof.

### Embodiment 6

Honeycomb paper comprising a honeycomb core comprising the corrugated paper according to any one of Embodiments 1 to 5.

### Embodiment 7

The honeycomb paper of Embodiment 6, further comprising a varnish or adhesive deposited on or absorbed within said corrugated paper.

### Embodiment 8

The honeycomb paper of Embodiment 6, further comprising a protective layer bound to a surface of the honeycomb core.

### Embodiment 9

The honeycomb paper of Embodiment 8, wherein said protective layer comprises polycarbonate copolymer film, glass fiber mat entrained with polyimide, liquid crystal polymer mat, carbon fiber fabric, flame retardant fabric, sheet metal, non-woven reinforced polymer sheet, or a combination thereof.

### Embodiment 10

An article comprising the honeycomb paper of any one of Embodiments 6 to 9.

### Embodiment 11

The article of Embodiment 10 comprising structural panels for use in transportation, furniture, pallets, and containers.

### Embodiment 12

The article of Embodiment 11 comprising floors, walls, ceilings, doors, lids, covers, seats, tables, counters, or a combination thereof.

### Embodiment 13

A method of making a honeycomb paper comprising: forming corrugated papers according to any one of Embodiments 1 to 5, wherein the corrugated papers have high surfaces on each opposing side; applying an adhering agent to the high surfaces of at least one side of the corrugated papers; and stacking corrugated papers having an adhering agent to contact the high surfaces of adjacent papers with adhering agent disposed between the contacting high surfaces.

### Embodiment 14

The method of Embodiment 13, further comprising cutting the honeycomb paper to yield honeycomb cores of desired thickness.

### Embodiment 15

The method of claim 14, further comprising binding a protective layer to a surface of the honeycomb core.

### Embodiment 16

The method of Embodiment 15, wherein said protective layer comprises polycarbonate copolymer film, glass fiber mat entrained with polyimide, liquid crystal polymer mat, carbon fiber fabric, flame retardant fabric, sheet metal, non-woven reinforced polymer sheet, or a combination thereof.

### Embodiment 1

A method of making a honeycomb structure comprising: forming corrugated papers according to any one of Embodiments 1 to 5, wherein the corrugated papers have high surfaces on each opposing side; applying an adhering agent to the high surfaces of at least one side of the corrugated papers; partially cutting the corrugated paper; and folding the corrugated paper having an adhering agent to contact the high surfaces with adhering agent to another high surface.

### Embodiment 18

The method of Embodiment 17, wherein the high surfaces with adhering agent are contacted with high surfaces having adhering agent.

### Embodiment 19

The method of Embodiment 17 or 18, further comprising cutting the honeycomb structure to yield honeycomb cores of desired thickness.

### Embodiment 20

The method of Embodiments 17, 18 or 19, further comprising binding a protective layer to a surface of the honeycomb core.

In general, the compositions or methods can alternatively comprise, consist of, or consist essentially of, any appropriate components or steps herein disclosed. The invention can additionally, or alternatively, be formulated so as to be devoid, or substantially free, of any components, materials, ingredients, adjuvants, or species, or steps used in the prior art compositions or that are otherwise not necessary to the achievement of the function and/or objectives of the present claims. The modifier “about” used in connection with a quantity is inclusive of the stated value and has the meaning dictated by the context (e.g., includes the degree of error associated with measurement of the particular quantity). The endpoints of all ranges directed to the same component or property are inclusive of the endpoints, are independently combinable, and include all intermediate points and ranges optional. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation. The term “combination” is inclusive of blends, mixtures, alloys, reaction products, and the like. Unless defined otherwise, technical and scientific terms used herein have the same meaning as is commonly understood by one of skill in the art to which this invention belongs. Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. All molecular weights in this application refer to weight average molecular weights unless indicated otherwise. All such mentioned molecular weights are expressed in Daltons. All ASTM tests are based on the 2003 edition of the Annual Book of ASTM Standards unless otherwise indicated.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A corrugated paper comprising a consolidated fibrous mat comprising
1 to 65 weight percent of high modulus reinforcing fibers; and
a continuous phase connecting the reinforcing fibers, the continuous phase comprising
35 to 99 weight percent of a thermoplastic polymer fiber having a processing temperature at least 20° C. lower than the reinforcing fibers,
0 to 65 weight percent of a high strength toughening fiber, and
0 to 10 weight percent of a binder fiber having a melt temperature lower than the thermoplastic polymer;
wherein the weight percent of each of the reinforcing fibers, the thermoplastic polymer fiber, toughening fiber and the binder fiber is based on the combined total weight of the reinforcing fibers, the thermoplastic polymer fibers, and the binder fiber.

2. The corrugated paper of claim 1, wherein
the high modulus reinforcing fibers comprise carbon fibers having a modulus greater than or equal to 20 msi and below 90 msi, glass fibers, basalt fibers, alumina, or a combination comprising at least one of the foregoing fibers;
the thermoplastic polymer fiber comprises a polyetherimide, polyetherimide sulfone, polyphenylene sulfide, or a combination thereof;
the high strength toughening fiber comprising poly(p-phenylene-2,6-benzobisoxazole), liquid crystal polymer, nylon, aramids, para aramids, mixed aramids, plant derived fibers, or a combination thereof; and
the binder fiber comprises polycarbonate copolymer, polyalkylene terephthalate, polyether ether ketone, polyamide, or a combination thereof.

3. A Corrugated paper comprising a thermoplastic polymer layer and a layer of high modulus fiber cloth layer stacked and formed into corrugated sheets.

4. The corrugated paper of claim 3, wherein the thermoplastic polymer layer comprises a consolidated fibrous mat comprising
1 to 65 weight percent of high modulus reinforcing fibers; and
a continuous phase connecting the reinforcing fibers, comprising
35 to 99 weight percent of a thermoplastic polymer fiber having a processing temperature at least 20° C. lower than the reinforcing fibers,
0 to 65 weight percent of a high strength toughening fiber, and
0 to 10 weight percent of a binder fiber having a melt temperature lower than the polymer;
wherein the weight percent of each of the reinforcing fibers, the thermoplastic polymer fiber, toughening fiber and binder fiber is based on the combined total weight of the reinforcing fibers, the thermoplastic polymer fibers, and the binder fiber.

5. The corrugated paper of claim 4, wherein the high modulus reinforcing fibers comprise carbon fibers having a modulus above 20 msi and below 90 msi, glass fibers, basalt fibers, alumina, or a combination comprising at least one of the foregoing fibers;
the thermoplastic polymer fiber comprises a polyetherimide, polyetherimide sulfone, polyphenylene sulfide, or a combination thereof;
the high strength toughening fiber comprising poly(p-phenylene-2,6-benzobisoxazole), liquid crystal polymer, nylon, aramids, para aramids, mixed aramids, plant derived fibers, or a combination thereof; and
the binder fiber comprises polycarbonate copolymer, polyalkylene terephthalate, polyether ether ketone, polyamide, or a combination thereof.

6. A honeycomb paper comprising a honeycomb core comprising the corrugated paper according to claim 1.

7. The honeycomb paper of claim 6, further comprising a varnish or adhesive deposited on or absorbed within said corrugated paper.

8. The honeycomb paper of claim 6, further comprising a protective layer bound to a surface of the honeycomb core.

9. The honeycomb paper of claim 8, wherein said protective layer comprises polycarbonate copolymer film, glass fiber mat entrained with polyimide, liquid crystal polymer mat, carbon fiber fabric, flame retardant fabric, sheet metal, non-woven reinforced polymer sheet, or a combination thereof.

10. An article comprising the honeycomb paper of claim 6.

11. The article of claim 10 comprising structural panels for use in transportation, furniture, pallets, and containers.

12. The article of claim 11 comprising floors, walls, ceilings, doors, lids, covers, seats, tables, counters, or a combination thereof.

13. A method of making a honeycomb paper comprising:
forming corrugated papers according to claim 1, wherein the corrugated papers have high surfaces on each opposing side;
applying an adhering agent to the high surfaces of at least one side of the corrugated papers; and
stacking corrugated papers having an adhering agent to contact the high surfaces of adjacent papers with adhering agent disposed between the contacting high surfaces.

14. The method of claim 13, further comprising cutting the honeycomb paper to yield honeycomb cores of desired thickness.

15. The method of claim 14, further comprising binding a protective layer to a surface of the honeycomb core.

16. The method of claim 15, wherein said protective layer comprises polycarbonate copolymer film, glass fiber mat entrained with polyimide, liquid crystal polymer mat, carbon fiber fabric, flame retardant fabric, sheet metal, non-woven reinforced polymer sheet, or a combination thereof.

17. A method of making a honeycomb structure comprising:
forming corrugated papers according to claim 1, wherein the corrugated papers have high surfaces on each opposing side;
applying an adhering agent to the high surfaces of at least one side of the corrugated papers;
partially cutting the corrugated paper; and
folding the corrugated paper having an adhering agent to contact the high surfaces with adhering agent to another high surface.

18. The method of claim 17, wherein the high surfaces with adhering agent are contacted with high surfaces having adhering agent.

19. The method of claim 17, further comprising cutting the honeycomb structure to yield honeycomb cores of desired thickness.

20. The method of claim 17, further comprising binding a protective layer to a surface of the honeycomb core.
